(19) United States
(12) Patent Application Publication
(10) Pub. No.: US 2022/0079377 A1
(43) Pub. Date: Mar. 17, 2022

(54) Automatic Tea Brewing and Making Device

(71) Applicant: JIANGSU ZHONGMING TEA SET TECHNOLOGY CO., LTD, Jiangsu (CN)

(72) Inventors: Jinsheng HAN, Jiangsu (CN); Mulin HAN, Jiangsu (CN)

(21) Appl. No.: 17/437,272

(22) PCT Filed: Mar. 5, 2020
(86) PCT No.: PCT/CN2020/078054

§ 371 Date: Sep. 8, 2021

(30) Foreign Application Priority Data
Mar. 8, 2019 (CN) 201910175911.0

(51) Int. Cl. A47J 31/56; A47J 31/06; A47J 31/46; A47J 31/52; A47J 31/44; H05B 1/02; H05B 6/10

(52) U.S. Cl. CPC A47J 31/56; A47J 31/0615; A47J 31/461; A47J 31/5255; A47J 31/5253; H05B 2203/021; A47J 31/4439; H05B 1/0269; H05B 6/108; A47J 2202/00; A47J 2203/00; A47J 31/468

(57) ABSTRACT

Disclosed is an automatic tea brewing and making device, comprising: a tea brewing and making container, an electronically controlled valve disposed at the bottom or the lower side of the tea brewing and making container, a first electric heating element, a water inlet pipe, a water injection control device provided on the water inlet pipe, and an electric control component. The electronically controlled valve is an electric valve or a solenoid valve. The tea brewing and making container is provided with an opening for filling water and putting tea leaves. The electric control component comprises a temperature detection device; and also comprises a controller. The temperature detection device, the water injection control device, the first electric heating element and the electronically controlled valve are all electrically connected with the controller.

### TECHNICAL FIELD

The present disclosure relates to the technical field of tea sets, and in particular to an automatic tea cooking and brewing device (an automatic tea brewing and making device).

### BACKGROUND ART

There is a long history for tea culture, and accordingly, there are various types of tea brewing appliances, for example, a tea cup, a tea bowl, a teapot with a drinking nozzle such as a teapot made of purple clay, etc. Regarding such common tea brewing appliances, the use method is usually to add tea leaves into the tea brewing appliances, and then to add boiling water or hot water to soak them to get tea water, where tea water is drunk with a cup mouth, a bowl mouth or a drinking nozzle provided above the appliance. As the society develops and as people's living standard has been continuously improved, tea sets are constantly introduced with new ones. In recent years, various automatic or semi-automatic tea brewing devices have been widely studied. For example, Chinese patent documents with the Patent Nos. CN205568527U, CN204683194U and CN206342271U, and the application publication No. CN108784361A all involve an automatic tea set. However, the tea set or device disclosed in the above documents only has the function of brewing tea. As people's living standard has been continuously improved, there are abundant varieties of tea leaves used for brewing tea, and there are increasing requirements on the taste of the tea. Although the existing common tea brewing appliances are convenient to use, they do not have the heating function and cannot cook tea. Therefore, in case of tea leaves such as Pu'er tea, most varieties of black tea, etc., which require cooking to highlight the taste of this kind of tea during tea brewing, it is difficult to meet the requirements with the current common tea brewing appliance. Moreover, different varieties of tea leaves have different requirements on water temperature for brewing tea, and the existing common tea brewing appliances do not have functions of knowing and controlling the water temperature.

### SUMMARY

An object of the present disclosure is, in view of the problem in the prior art, to provide an automatic tea cooking and brewing device which integrates functions of brewing tea and cooking tea, which temperature during cooking and brewing tea is able to be controlled, and has convenient operation for discharging tea water.

The technical solution of the present disclosure is as follows. An automatic tea cooking and brewing device of the present disclosure has the following structural features: comprising a tea cooking and brewing container, an electrically controlled valve provided at a bottom portion or a lateral lower portion of the above tea cooking and brewing container and configured to discharge tea water, a first electric heating element configured to heat the tea cooking and brewing container, a water inlet pipe configured to inject water into the tea cooking and brewing container, a water injection controlling device provided on the above water inlet pipe and configured to control supplying and stopping of water flow, and an electrically controlled assembly, wherein the above electrically controlled valve is an electrically operated valve or a solenoid valve; the above tea cooking and brewing container is provided with an opening making water injected and tea leaves put therein, and the above opening is in communication with a water source through the water inlet pipe in use; the above electrically controlled assembly comprises a temperature detecting device for detecting water temperature in the tea cooking and brewing container, and a controller for correspondingly controlling a connection and a disconnection of a power supply to the water injection controlling device, the first electric heating element and the electrically controlled valve according to a detected signal and a set parameter; the above temperature detecting device, the water injection controlling device, the first electric heating element and the electrically controlled valve are all electrically connected with the controller.

A further solution is that the above first electric heating element is provided at a bottom portion of outer side of the above tea cooking and brewing container, or the above first electric heating element is provided on a lateral outer peripheral wall of the tea cooking and brewing container, or the above first electric heating element is provided on the bottom portion and the lateral outer peripheral wall of the tea cooking and brewing container.

A further solution is that the above water injection controlling device is an electrically operated water pump, an electrically operated valve or a solenoid valve whose flow rate is compatible with the above tea cooking and brewing container.

A further solution is that the above electrically controlled assembly further comprises a first water amount detecting device for detecting water amount in the tea cooking and brewing container.

A further solution is that the above first water amount detecting device is a weighing sensor or the above first water amount detecting device is a liquid level sensor, or the above first water amount detecting device is a flow rate sensor provided on the above water inlet pipe.

A further solution is that the above first electric heating element is a resistance heating device.

A further solution is that the above first electric heating element is an electromagnetic heating coil; a material of a part of the above tea cooking and brewing container at least covered by the first electric heating element is a ferromagnetic material, or when the material of the tea cooking and brewing container is a non-ferromagnetic material, a ferromagnetic material layer is provided between the first electric heating element and the tea cooking and brewing container.

A further solution is that the above controller comprises a signal converting module, a CPU module, a human-machine interacting module, a relay group, a sound and light reminder module, and a power supply module, the above CPU module is electrically connected in signal with the signal converting module, the relay group is electrically connected in signal with the CPU module, and the human-machine interacting module and the sound and light reminder module are respectively electrically connected with the CPU module; the above temperature detecting device and the first water amount detecting device are respectively electrically connected with the signal converting module of the controller; the above electronically controlled valve, the first electric heating element, and the water injection controlling device are respectively electrically connected with a corresponding relay in the relay group of the controller; and the above temperature detecting device is a temperature sensor.

A further solution is that the above automatic tea cooking and brewing device further comprises a tea leaf filtering piece provided in the above tea cooking and brewing container.

A further solution is that the above automatic tea cooking and brewing device further comprises a bracket, a tea holding container movably provided on the above bracket, and a second electric heating element provided on the above bracket and configured to heat the above tea holding container; the above electrically controlled assembly further comprises a second water amount detecting device for detecting tea water amount in the tea holding container, the above second electric heating element and the second water amount detecting device are respectively electrically connected with the controller, and a connection and a disconnection of a power supply of the second electric heating element is controlled by the above controller.

A further solution is that the above bracket comprises a base, a vertical frame, a first transversal frame and a second transversal frame; the above vertical frame is integrally or fixedly provided at one side of the base; the first transversal frame is provided at an upper end of the vertical frame; and the second transversal frame is provided on the base and located below the first transversal frame; and the above tea cooking and brewing container is provided on the first transversal frame, and the tea holding container is placed on the second transversal frame; the above second water amount detecting device is a weighing sensor; the second water amount detecting device is provided between the second transversal frame and the base; and the second electric heating element is provided on the second transversal frame and is located at a position where the tea holding container is placed.

The present disclosure has positive effects as follows. (1) The automatic tea cooking and brewing device of the present disclosure, by using the electric heating element outside the tea cooking and brewing container, allows not only implementing the tea brewing function of the tea brewing appliance in the prior art, but also implementing a tea cooking function for a corresponding variety of tea leaves, and thus the automatic tea cooking and brewing device of the present disclosure is applicable for brewing and/or cooking different varieties of tea leaves, satisfying the taste and temperature required by tea drinkers on the tea water to the greatest extent. (2) The automatic tea cooking and brewing device of the present disclosure, by providing a water temperature monitoring device on the tea cooking and brewing container, which cooperates with the electrical heating element under an automatic control of the controller, allows temperature of water or tea water in the tea cooking and brewing container to be effectively and automatically controlled, and enables to provide corresponding water temperature for brewing tea and/or cooking tea according to the different varieties of tea used, thereby effectively improving quality of the tea water. (3) The automatic tea cooking and brewing device of the present disclosure, by providing a bracket, allows the automatic tea cooking and brewing device to be easily placed as a whole in use, and the automatic tea cooking and brewing device of the present disclosure, by providing a tea holding container on the bracket and by providing a second electric heating element on the bracket for heating the tea water in the tea holding container as needed, allows heating the tea water in the tea holding container whose temperature is reduced to a temperature that does not meet the needs of the drinker due to delayed drinking, where waste may be avoided. (4) By designing the whole structure, the automatic tea cooking and brewing device of the present disclosure in use can automatically control elements such as water temperature, water amount, and time for brewing and/or cooking tea according to different varieties of tea leaves, and thus allows tea water with the best taste to be brewed for different varieties of tea leaves; and moreover, the automatic tea cooking and brewing device of the present disclosure can achieve a full automation of adding water, boiling water, brewing and/or cooking tea and discharging tea water, with a high degree of automation, and being convenient and safe in use. (5) With the automatic tea cooking and brewing device of the present disclosure, the tea leaves that need to be cooked together with cold water are put into the tea cooking and brewing container, and then electric heating cooks the tea starting from cold water. Experiments show that the taste of the tea water can be significantly improved and damage to beneficial substances of the tea leaves is reduced.

### BRIEF DESCRIPTION OF DRAWINGS

FIG. 1 is a structural schematic view of one embodiment of the present disclosure;

FIG. 2 is a structural schematic view of another embodiment of the present disclosure; and

FIG. 3 is a schematic diagram of a circuit structure of the present disclosure.

Reference signs in the above figures are listed as follows:
bracket 1; base 11; vertical frame 12; first transversal frame 13; second transversal frame 14; tea cooking and brewing container 2; opening 21; tea leaf filtering piece 22; water inlet pipe 3; electrically controlled valve 4; first electric heating element 5; water injection controlling device 6: tea holding container 7; second electric heating element 8; electrically controlled assembly 9; temperature detecting device 91; liquid level sensor 92: first weighing sensor 93; second weighing sensor 94; controller 95.

### DETAILED DESCRIPTION OF THE EMBODIMENTS

The present disclosure will be further described in detail below in connection with the drawings and the specific embodiments.

### Embodiment 1

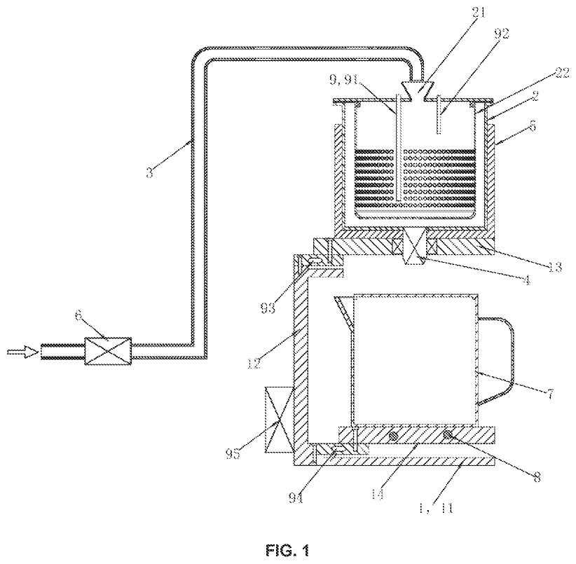

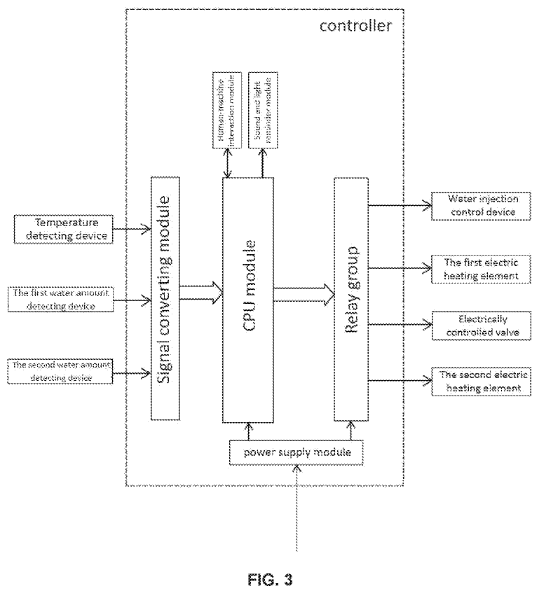

As shown in FIGS. 1 and 3, the automatic tea cooking and brewing device of the embodiment is mainly consisting of a bracket 1, a tea cooking and brewing container 2, a water inlet pipe 3, an electrically controlled valve 4, a first electric heating element 5, a water injection controlling device 6, a tea holding container 7, a second electric heating element 8, and an electrically controlled assembly 9.

The bracket 1 is configured to install and support related members of the device. The bracket 1 is mainly consisting of a base 11, a vertical frame 12, a first transversal frame 13, and a second transversal frame 14; the vertical frame 12 is integrally or fixedly provided at one side of the base 11; the first transversal frame 13 is provided at an upper end of the vertical frame 12; and regarding the second transversal frame 14, as a preferred mode, the second transversal frame 14 is provided on the base 11 and located below the first transversal frame 13.

The tea cooking and brewing container 2 is a hollow member, and the tea cooking and brewing container 2 is provided thereon with an opening 21 making water injected and tea leaves put therein. In the embodiment, the opening 21 is preferably provided above the tea cooking and brewing container 2; the tea cooking and brewing container 2 at least comprises a bottom plate and a wall body integrally or hermetically fixedly connected, and in the embodiment, a liquid outlet is provided on a bottom plate of the tea cooking and brewing container 2. The tea cooking and brewing container 2 is fixedly provided on the first transversal frame 13 of the bracket 1. As a preferred mode, the tea cooking and brewing container 2 is provided therein with a tea leaf filtering piece 22; the tea leaf filtering piece 22 is a member consisting of a bottom plate and a wall plate; the bottom plate and/or the wall plate of the tea leaf filtering piece 22 are provided with filtering holes; and the shape and the size of the tea leaf filtering piece 22 are adapted to the tea cooking and brewing container 2.

The water inlet pipe 3 is configured to inject water into the tea cooking and brewing container 2, one end of the water inlet pipe 3 communicates with the opening 21 of the tea cooking and brewing container 2, and the other end of the water inlet pipe 3 is externally connected to a water source in use.

The electrically controlled valve 4 may adopt an electrically operated valve or a solenoid valve. The electrically controlled valve 4 is hermetically and fixedly provided at the liquid outlet of the tea cooking and brewing container 2. That is, the electrically controlled valve 4 is hermetically and fixedly provided on the bottom plate of the tea cooking and brewing container 2, the water outlet of the electrically controlled valve 4 protrudes downward, and the electrically controlled valve 4 is configured to discharge tea water in use. When the electrically controlled valve 4 adopts an electrically operated valve, the electrically operated valve used is a commercially available product, and when the electrically controlled valve 4 adopts a solenoid valve, it is also a product in the prior art, for example, the liquid communicating solenoid valve disclosed in the Chinese patent document with the application publication number CN108825801A.

The first electric heating element 5 is configured to electrically heat the tea cooking and brewing container 2 in use. The first electric heating element 5 may be provided below a bottom plate of the tea cooking and brewing container 2, or on an outer peripheral wall of the tea cooking and brewing container 2, and in the embodiment, the first electric heating element 5 is preferably provided below the bottom plate of the tea cooking and brewing container 2 and the outer peripheral wall of the wall body. The first electric heating element 5 may adopt a resistance heating device or may adopt an electromagnetic heating coil; when the first electric heating element 5 adopts an electromagnetic heating coil, a material of a part of the tea cooking and brewing container 2 at least covered by the first electric heating element 5 is a ferromagnetic material, or when the material of the tea cooking and brewing container 2 is a non-ferromagnetic material, a ferromagnetic material layer (not shown in the Figure) is provided between the first electric heating element 5 and the tea cooking and brewing container 2, so that the electromagnetic heating coil can heat the tea cooking and brewing container 2. The structure and working principle of the electromagnetic heating coil are the prior art, and are not described in detail here.

The water injection controlling device 6 is provided on the water inlet pipe 3 and is configured to automatically control water injected into the tea cooking and brewing container 2. The water injection controlling device 6 may adopt an electrically operated water pump, an electrically operated valve or a solenoid valve whose flow rate is compatible with a volume of the tea cooking and brewing container 2. In the embodiment, the water injection controlling device 6 preferably adopts an electrically operated water pump.

As a preferred mode, the tea holding container 7 and the second electric heating element 8 are provided in cooperation with the second transversal frame 14 of the bracket 1, and the tea holding container 7 is a commercially available product with a liquid inlet, for example, a tea cup, a tea bowl or a teapot, etc. The tea holding container 7 is placed on the second transversal frame 14 in use, and the liquid inlet of the tea holding container 7 is located below the liquid outlet of the electrically controlled valve 4; the second electric heating element 8 is provided on the second transversal frame 14 and located at a position where the tea holding container 7 is placed, and the second electric heating element 8 adopts a resistance heating element. In use, the second electric heating element 8 is configured to heat the tea holding container 7 holding the tea water as needed.

The electronically controlled assembly 9 comprises a temperature detecting device 91, a first water amount detecting device, a second water amount detecting device and a controller 95.

The temperature detecting device 91 is provided on the tea cooking and brewing container 2 for detecting tea water temperature in the tea cooking and brewing container 2, and the temperature detecting device 91 in the embodiment preferably adopts a temperature sensor. The first water amount detecting device is configured to detect tea water amount in the tea cooking and brewing container 2. The first water amount detecting device may adopt a liquid level sensor 92 provided on the tea cooking and brewing container 2, the first water amount detecting device may also adopt a first weighing sensor 93 provided between the first transversal frame 13 of the bracket 1 and an upper portion of the vertical frame 12, and the first water amount detecting device may also adopt a flow rate sensor (not shown in the figure) provided on the water inlet pipe 3. As a preferred mode, the second water amount detecting device is provided in cooperation with the tea holding container 7 to detect tea water amount in the tea holding container 7. The second water amount detecting device preferably adopts a second weighing sensor 94 provided between the second transversal frame 14 and the base 11 of the bracket 1.

The controller 95 may be installed on the bracket 1, or may be installed independently. Referring to FIG. 3, the controller is mainly consisting of a signal converting module, a CPU module, a human-machine interacting module, a relay group, and a power supply module. The CPU module is electrically connected in signal with the signal converting module, the relay group is electrically connected in signal with the CPU module, and the human-machine interacting module is electrically connected with the CPU module respectively. The signal converting module is configured to convert signals, such as water temperature in the tea cooking and brewing container 2 detected by the temperature detecting device 91, the tea water amount in the tea cooking and brewing container 2 detected by the first water amount detecting device, and the tea water amount in the tea holding container 7 detected by the second water amount detecting device, into signals that can be received by the CPU module and send to the CPU module. The signal converting module is a conventional circuit module in the prior art, and its structure is not described in detail here. The human-machine interacting module, preferably a touch screen, is configured to set parameters including water amount for cooking/brewing tea, water temperature for cooking/brewing tea, and time for cooking/brewing tea according to different varieties of tea leaves, and to display working status in real time in use; the relay group, including several relays, is configured to control a connection and a disconnection of a power supply to the electrically controlled valve 4, the first electric heating element 5, and the second electric heating element 8 according to an instruction of the CPU module; the CPU module is configured to realize a main control of the device; and the CPU module includes a CPU chip and a memory, where program built into the CPU chip is a simple prior art program. The power supply module is configured to provide working power supply. In use, an input end of the power supply module is connected to the mains supply. As a preferred mode, the controller 95 further comprises a sound and light reminder module for reminding the working status; the sound and light reminder module is electrically connected with the CPU module, and in the embodiment, the sound and light reminder module is consisting of a buzzer and an LED lamp. The functional modules of the controller 95 are all mature existing technologies.

The foregoing temperature detecting device 91, the foregoing first water amount detecting device, and the foregoing second water amount detecting device are respectively electrically connected to the signal converting module of the controller 95; the electronically controlled valve 4, the first electric heating element 5 and the second electric heating element 8 are respectively electrically connected with a corresponding relay in the relay group of the controller 95.

The use method and working principle of the automatic tea cooking and brewing device of the embodiment are briefly described as follows:

regarding the automatic tea cooking and brewing device of the embodiment in use, a user turns on the power to the device, and first chooses tea cooking or tea brewing through the human-machine interacting module of the controller 95 as needed.

If the user chooses tea cooking, the user first puts the selected tea leaves into the tea leaf filtering piece 22 of the tea cooking and brewing container 2, and then inputs as needed, through the human-machine interacting module of the controller 95, parameters such as water amount for cooking tea, the highest water temperature for cooking tea, and time for cooking tea to the CPU module, correspondingly; and the parameters are sent to the CPU module for storage; the second weighing sensor 94 detects in real time whether the tea holding container 7 has been placed on the second transversal frame 14, and if the tea holding container 7 has been placed on the second transversal frame, after receiving a signal of the second weighing sensor 94, the CPU module activates, through the relay group, the water injection controlling device 6 to inject cold water into the tea cooking and brewing container 2 with tea leaves through the water inlet pipe 3; the first water amount detecting device detects in real time water amount in the tea cooking and brewing container 2, and when the water amount in the tea cooking and brewing container 2 reaches a set value, the controller 95 turns off the power of the water injection controlling device 6 to stop injecting water, and the CPU module of the controller 95 controls, through the relay group, the first electric heating element 5 to power on, so as to heat the water in the tea cooking and brewing container 2; the CPU module of the controller 95 starts timing the time for cooking tea since the power of the first electric heating element 5 is turned on, and the temperature detecting device 91 detects in real time water temperature in the tea cooking and brewing container 2; when the water in the tea cooking and brewing container 2 is heated to a set maximum temperature, the controller 95 maintains the set temperature for continuing the tea cooking through a cooperation control of the temperature detecting device 91 and the first electric heating element 5; when the timing reaches the set time for tea cooking, the sound and light reminder module of the controller 95 sends out sound and light reminders to remind that the tea water is ready for drinking. The controller 95 controls the first electric heating element 5 to power off. At the same time, the CPU module of the controller 95 controls, through the relay group, the electrically controlled valve 4 to power on, so as to start injecting tea water into the tea holding container 7 until the tea water in the tea cooking and brewing container 2 is basically emptied. The second weighing sensor 94 monitors in real time the tea water amount added into the tea holding container 7 and feeds back a signal to the CPU module in real time. After the tea water in the tea holding container 7 reaches a set amount, the CPU module closes the electrically controlled valve 4 through the relay group to stop discharging tea water, and the user drinks tea through the tea holding container 7.

If the user chooses tea brewing, the difference from the foregoing tea cooking lies in that water is first added to the tea cooking and brewing container 2, and then water is heated to a set temperature and then power of the first electric heating element 5 is automatically turned off; then the selected tea leaves are put into the tea leaf filtering piece 22 of the tea cooking and brewing container 2 to brew tea, and time for tea brewing is timed, and tea water is automatically discharged when the set time is reached.

During use, if the tea water in the tea holding container 7 gets cold and needs to be heated, the tea holding container 7 may be placed on the second transversal frame 14, and through operating the human-machine interaction module of the controller 95, the second electric heating element 8 controlled by the controller 95 is started to power on, so as to heat the tea holding container 7, avoiding waste.

### Embodiment 2

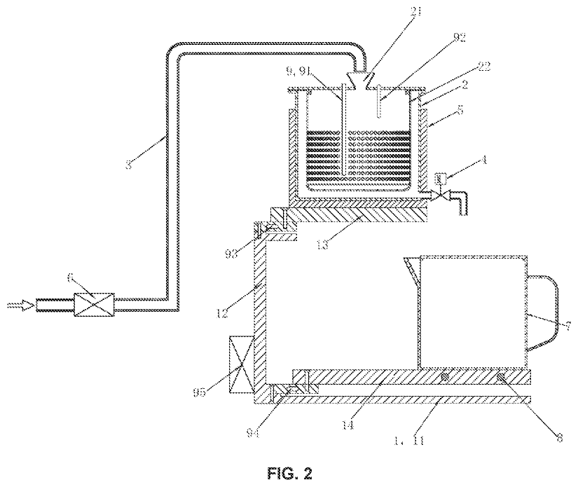

As shown in FIG. 2, the automatic tea cooking and brewing device of the embodiment is basically the same as that of Embodiment 1 in other respects, with the difference that a liquid outlet of the tea cooking and brewing container 2 is provided at a lateral lower side of the tea cooking and brewing container, that is, at a junction of the wall body and the bottom plate of the tea cooking and brewing container 2, and the electrically controlled valve 4 is hermetically provided above the liquid outlet of the tea cooking and brewing container 2 and discharges water downward.

The above embodiments are descriptions of specific implementations of the present disclosure, rather than limitations to the present disclosure. Those skilled in the related art can also make various transforms and changes to obtain corresponding equivalent technical solutions without departing from the spirit and scope of the present disclosure. Therefore, all equivalent technical solutions should be included in the patent scope of protection of the present disclosure.

1. An automatic tea cooking and brewing device, comprising a tea cooking and brewing container, an electrically controlled valve provided at a bottom portion or a lateral lower portion of the tea cooking and brewing container and configured to discharge tea water, a first electric heating element configured to heat the tea cooking and brewing container, a water inlet pipe configured to inject water into the tea cooking and brewing container, a water injection controlling device provided on the water inlet pipe and configured to control supplying and stopping of water flow, and an electrically controlled assembly, wherein the electrically controlled valve is an electrically operated valve or a solenoid valve; the tea cooking and brewing container is provided with an opening which allows water to be injected and tea leaves to be put therein, and the opening is in communication with a water source through the water inlet pipe in use; the electrically controlled assembly comprises a temperature detecting device for detecting water temperature in the tea cooking and brewing container, and a controller for correspondingly controlling a connection and a disconnection of a power supply to the water injection controlling device, the first electric heating element and the electrically controlled valve according to a detected signal and a set parameter; and the temperature detecting device, the water injection controlling device, the first electric heating element and the electrically controlled valve are all electrically connected with the controller.

2. The automatic tea cooking and brewing device according to claim 1, wherein the first electric heating element is provided at a bottom of an outer side of the tea cooking and brewing container, or the first electric heating element is provided on a lateral outer peripheral wall of the tea cooking and brewing container, or the first electric heating element is provided on the bottom and the lateral outer peripheral wall of the tea cooking and brewing container.

3. The automatic tea cooking and brewing device according to claim 1, wherein the water injection controlling device is an electrically operated water pump, an electrically operated valve or a solenoid valve, whose flow rate is compatible with the tea cooking and brewing container.

4. The automatic tea cooking and brewing device according to claim 1, wherein the electrically controlled assembly further comprises a first water amount detecting device for detecting water amount in the tea cooking and brewing container.

5. The automatic tea cooking and brewing device according to claim 4, wherein the first water amount detecting device is a weighing sensor or the first water amount detecting device is a liquid level sensor, or the first water amount detecting device is a flow rate sensor provided on the water inlet pipe.

6. The automatic tea cooking and brewing device according to claim 1, wherein the first electric heating element is a resistance heating device.

7. The automatic tea cooking and brewing device according to claim 1, wherein the first electric heating element is an electromagnetic heating coil; a material of a part of the tea cooking and brewing container at least covered by the first electric heating element is a ferromagnetic material, or when a material of the tea cooking and brewing container is a non-ferromagnetic material, a ferromagnetic material layer is provided between the first electric heating element and the tea cooking and brewing container.

8. The automatic tea cooking and brewing device according to claim 4, wherein the controller comprises a signal converting module, a CPU module, a human-machine interacting module, a relay group, a sound and light reminder module, and a power supply module, wherein the CPU module is electrically connected in signal with the signal converting module, the relay group is electrically connected in signal with the CPU module, and the human-machine interacting module and the sound and light reminder module are respectively electrically connected with the CPU module; the temperature detecting device and the first water amount detecting device are respectively electrically connected with the signal converting module of the controller; the electronically controlled valve, the first electric heating element, and the water injection control device are respectively electrically connected with a corresponding relay in the relay group of the controller; and the temperature detecting device is a temperature sensor.

9. The automatic tea cooking and brewing device according to claim 1, further comprising a tea leaf filtering piece provided in the tea cooking and brewing container.

10. The automatic tea cooking and brewing device according to claim 1, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

11. The automatic tea cooking and brewing device according to claim 10, wherein the bracket comprises a base, a vertical frame, a first transversal frame and a second transversal frame, wherein the vertical frame is integrally or fixedly provided at one side of the base; the first transversal frame is provided at an upper end of the vertical frame; and the second transversal frame is provided on the base and located below the first transversal frame; and
the tea cooking and brewing container is provided on the first transversal frame, and the tea holding container is placed on the second transversal frame: the second water amount detecting device is a weighing sensor; the second water amount detecting device is provided between the second transversal frame and the base; and the second electric heating element is provided on the second transversal frame and is located at a position where the tea holding container is placed.

12. The automatic tea cooking and brewing device according to claim 2, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

13. The automatic tea cooking and brewing device according to claim 3, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

14. The automatic tea cooking and brewing device according to claim 4, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

15. The automatic tea cooking and brewing device according to claim 5, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

16. The automatic tea cooking and brewing device according to claim 6, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

17. The automatic tea cooking and brewing device according to claim 7, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

18. The automatic tea cooking and brewing device according to claim 8, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.

19. The automatic tea cooking and brewing device according to claim 9, wherein the automatic tea cooking and brewing device further comprises a bracket, a tea holding container movably provided on the bracket, and a second electric heating element provided on the bracket and configured to heat the tea holding container; and the electrically controlled assembly further comprises a second water amount detecting device for detecting tea water amount in the tea holding container, the second electric heating element and the second water amount detecting device are respectively electrically connected with the controller, and a connection and a disconnection of a power supply of the second electric heating element is controlled by the controller.
